(19) United States
(12) Patent Application Publication
(10) Pub. No.: US 2014/0200025 A1
(43) Pub. Date: Jul. 17, 2014

(54) LOCATION DISCREPANCY CORRECTIONS BASED ON COMMUNITY CORRECTIONS AND TRAJECTORY DETECTION

(71) Applicants: Rita H. Wouhavbi, Portland, OR (US); Tobias M. Kohlenberg, Portland, OR (US); Stanley Mo, Hillsboro, OR (US); Mubashir A. Mian, Santa Clara, CA (US)

(72) Inventors: Rita H. Wouhavbi, Portland, OR (US); Tobias M. Kohlenberg, Portland, OR (US); Stanley Mo, Hillsboro, OR (US); Mubashir A. Mian, Santa Clara, CA (US)

(21) Appl. No.: 13/996,049

(22) PCT Filed: Feb. 29, 2012
(86) PCT No.: PCT/US12/27077

§ 371 Date: Mar. 27, 2014

(51) Int. Cl. H04W 64/00

(52) U.S. Cl. CPC H04W 64/00
USPC 455/456.1

(57) ABSTRACT

Generally, this disclosure describes location discrepancy fixes using a community of users. A method may include correcting a location of a mobile device when a location signal is lost based on a last known location and a trajectory, wherein a corrected location corresponds to an actual location provided by at least one user of a community of users and stored in a list of corrected locations, and the actual location is related to the last known location and the trajectory.

### FIELD

This disclosure relates to location discrepancy fixes, more particularly fixes based on community corrections and trajectory detection.

### BACKGROUND

Existing location services on mobile devices (e.g., smartphones and tablet computers) typically rely on GPS (Global Positioning System) for detecting and reporting location. When a GPS signal is unavailable, e.g., inside some buildings or in parks with heavy tree canopies, a location application running on the mobile device may attempt to determine the device's location using other sources such as a signal from a wireless access point. The wireless access point and IP address may be registered to an entity that is located a distance from the access point. The current location of the mobile device may be determined to be the location of the entity. Thus, the current location, as determined using the wireless access point may be remote from the actual location of the mobile device.

For example, wireless access points in the Moscone Center in San Francisco, Calif. are registered to a company located in Las Vegas, Nev. A mobile device may correctly report its location as a street in San Francisco while its associated user is on the street. When the user and mobile device enter the Moscone Center, the mobile device may incorrectly report its location as Las Vegas, Nev. This incorrect location may then interfere with the user's ability to find nearby places of interest or to communicate his or her actual location to others in the user's social network. Further, applications (“apps”) that are configured to report the user's location such as Google Latitude or Foursquare may report the incorrect location and may ban the user from the service based on the incorrect location information.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1 illustrates a location correction system consistent with various embodiments of the present disclosure;

FIG. 2 illustrates a flowchart of exemplary operations consistent with an embodiment of the present disclosure; and

FIG. 3 illustrates a flowchart of exemplary operations consistent with one embodiment of the present disclosure.

Although the following Detailed Description will proceed with reference being made to illustrative embodiments, many alternatives, modifications, and variations thereof will be apparent to those skilled in the art.

### DETAILED DESCRIPTION

Generally, this disclosure describes techniques for location correction using a community of users. The community of users may populate a database of corrected locations. Each corrected location may be associated with a last known location and/or a trajectory. When a mobile device becomes unable to determine its correct location (e.g., loses a location signal), a location correction application is configured to determine the mobile device's current location based on the mobile device's last known location and trajectory. “Location”, as used herein, includes, but is not limited to, GPS coordinates, a street address, a landmark (e.g., a park), a business (e.g., a shopping mall, a store) and/or another entity (e.g., a hospital). If the last known location and trajectory do not correspond to a corrected location, the user may be asked to provide the actual location. The actual location may be stored in the corrected location database and associated with the last known location and trajectory. If the last known location and trajectory correspond to one corrected location, then the mobile device current location may be set to the corrected location. The user may be asked to confirm that the corrected location corresponds to his/her actual location and, if not, may be asked to enter his/her actual location. If the last known location and trajectory correspond to more than one corrected location, the user may be asked to select the actual location from a list of corrected locations. The database of corrected locations may then be updated to reflect the user's selection and/or correction.

Over time, the database of corrected locations, associated last known locations and associated trajectories may include many locations where typical location signals (e.g., GPS) are unavailable and alternative location information (e.g., wireless access points) provides erroneous location information. Subsequent users may thus benefit from the database of locations populated by the community of prior users. Location-dependent applications may again function properly based on the accurate current location (i.e., corrected location) of the mobile device (and user), when, for example, a GPS location signal is unavailable.

A location correction system consistent with the present disclosure may be configured to provide a corrected location as stand-alone system and/or may be configured to function with one or more existing mapping and location-based systems, e.g., Google Maps, Mapquest, Yahoo Maps, and the like.

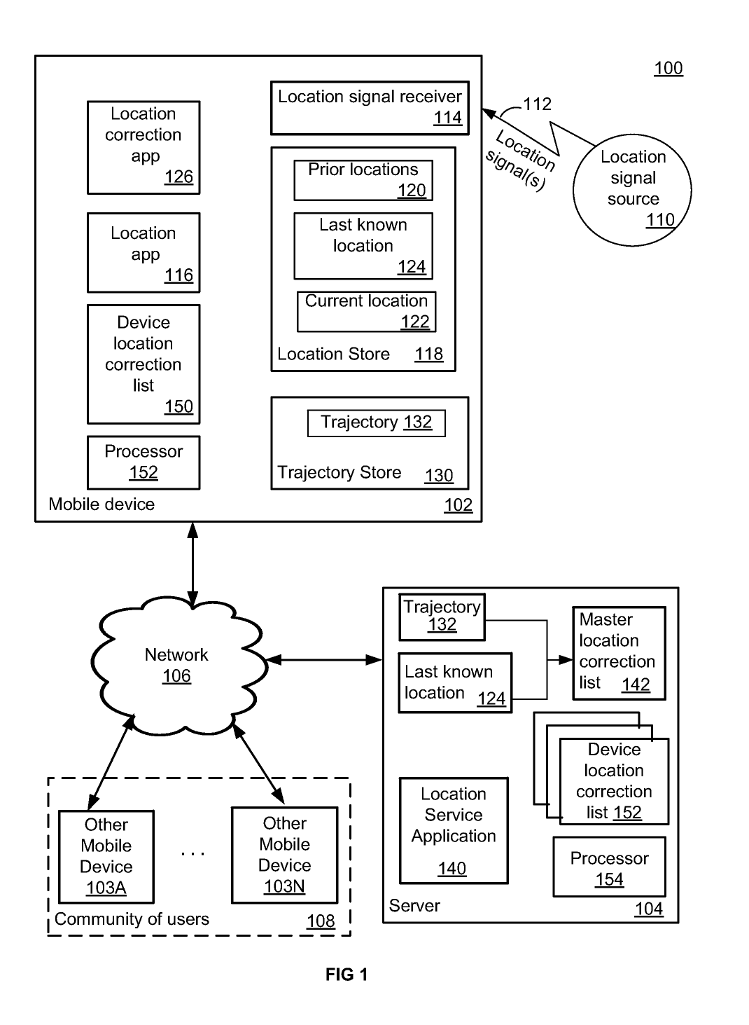

FIG. 1 illustrates a location correction system 100 consistent with various embodiments of the present disclosure. The system 100 generally includes a mobile device 102, a server 104, a network 106 and a community of users 108. “Mobile device” as used herein means any handheld computing device, including, but not limited to, mobile telephones, smartphones, tablet computers, notebook computers, ultraportable computers, ultramobile computers, netbook computers, subnotebook computers, personal digital assistants, enterprise digital assistants, mobile internet devices and personal navigation devices. The system 100 may include a location signal source 110 configured to generate relatively reliable location signal(s) 112. When the location signal(s) 112 are received by the mobile device 102, the mobile device 102 may be configured to detect its position based on the location signal(s) 112. The mobile device 102 may include a location signal receiver 114 configured to receive location signal(s) 112.

Mobile device 102 may include a processor, CPU 152, configured to perform the operations of one or more applications as described herein. Mobile device 102 may include a location application 116 configured to determine a current location of the mobile device 102 based on the received location signal(s) 112. For example, the location application 116 may be included in a mapping application such as Google Maps, Mapquest, Yahoo Maps, or the like. In another example, location app 116 may be a dedicated location application associated with one or more embodiments of the location correction system 100, as described herein.

For example, signal source 110 may include one or more components of the Global Positioning System (GPS). GPS is a satellite-based navigation system that transmits location signal(s) to earth. The location signal(s) and triangulation techniques may then be used to determine a device's location. The location signal receiver 114 is configured to receive the location signal(s) and the location application 116 is configured to determine a location of mobile device 102 based on the location signal(s) 112.

Mobile device 102 may include a location store 118, configured to store a current location 122 and one or more prior locations 120 of the mobile device 102. The current location 122 may be determined at predetermined time intervals (when the location signal(s) 112 can be received). At the expiration of each time interval, the current location may become a prior location, and a new current location may be determined and stored as current location 122. A finite number of prior locations may be stored so that an oldest prior location may be deleted when a newest prior location is stored. Thus, the location store 118 may include a plurality of prior locations of the mobile device 102. The prior locations 120 may be used to determine a trajectory of the mobile device 102 as described herein.

In some physical locations, the mobile device 102 may be unable to receive the location signal(s) 112. As the physical location of the mobile device 102 changes, the mobile device 102 may transition from receiving the location signal(s) 112 to not receiving the location signal(s) 112. When loss of the location signal(s) 112 occurs, the location store 118 may include the plurality of prior locations 120 and the current location 122.

The location application 116 is configured to determine the location of the mobile device 102 based on an alternative signal other than the location signal(s) 112 when the location signal(s) 112 are lost (i.e., unavailable or unreceivable). While the location signal(s) 112 may typically be highly reliable (e.g., GPS), the alternative signal may be much less reliable (and possibly unreliable) and the change in signal source may occur without notice to the user. The alternative signal may be a wireless signal, including, but not limited to, NFC, RFID, Wi-Fi, Bluetooth, 3G, 4G and/or some other wireless signal and/or may be a sensor signal, e.g., an audio signal from a microphone that may be used to estimate location. For example, the location application 116 may be configured to determine location based on a signal from a wireless access point and an address associated with the wireless access point. In some situations, the address associated with the wireless access point may not correspond to the location of the access point and may be remote from the location of the access point. The location application 116 may nonetheless store the erroneous location as the current location 122 of the mobile device 102.

Without additional input, the location application is unable to determine an accurate current location when the location signal(s) 112 are lost. While a user may be asked to enter the actual location whenever the location signal(s) 112 are lost, repeated requests may become tiresome. Techniques consistent with the present disclosure are configured to provide corrections for the current location without repeatedly asking a user to enter the actual location.

The mobile device 102 may include a location correction application 126. The location correction application 126 is configured to determine a corrected current location of the mobile device 102 when the relatively reliable location signal(s) 112 are lost. The corrected current location may replace an obsolete current location and/or replace an erroneous current location. The location correction application 126 may be configured to determine the corrected current location of mobile device 102 in response to the loss of the location signal(s) 112 and/or in response to a user input (e.g., selecting a location correction icon displayed on the mobile device).

The location correction application 126 is configured to determine the corrected current location based on the last known location 124 and one or more of the plurality of prior locations. The location correction application 126 is configured to store the last known location 124 in the location store 118 in response to loss of the location signal(s) 112. The last known location 124 may correspond to one of the plurality of prior locations 120 or may correspond to the current location 122 when the location signal(s) 112 were lost. For example, if the current location 122 is wrong (e.g., determined based on an access point address that differs from the access point location), then the last known location may correspond to one of the plurality of prior locations 120. In another example, if the current location 122 has not been updated since the location signal(s) 112 were lost, the last known location 124 may correspond to the current location 122.

It should be noted that “current location”, as used herein, may or may not correspond to the actual location of mobile device 102. “Actual location” is the actual physical location of the mobile device 102. Thus, “current location” corresponds to the location of the mobile device 102 as determined by an application. The mobile device 102 may include a trajectory store 130 configured to store a trajectory 132. The location correction application 126 is configured to determine a trajectory 132. The trajectory 132 may be determined in response to a loss of the location signal(s) 112. The trajectory 132 may be determined based on one or more of the plurality of prior locations 120 and/or the current (and non-erroneous) location 122. The trajectory may correspond to a direction of motion of the mobile device 102 prior to loss of the location signal(s) 112 and may include a rate of change of location. For example, the trajectory 132 may correspond to a velocity (vector) including a magnitude (e.g., rate of change of position) and a direction (e.g., direction of motion). The last known location 124 and the trajectory 132 may be utilized to determine and/or correct a current location when the location signal(s) 112 are unavailable. For example, the last known location 124 and the trajectory 132 may be used as indexes into a location correction database that includes a list of corrected locations associated with last known locations and trajectories. The database may be populated by a community of users as described herein.

It should be noted that a corrected location associated with a last known location and trajectory may include a plurality of related locations and/or may include a region related to the corrected location. For example, the corrected location may correspond to a center of a circular region with related locations anywhere within a radius of the corrected location. In another example, the last known location and trajectory may be associated with an entity such as a shopping mall that may include a plurality of sub-location, e.g., stores. Thus, the corrected location database may include a plurality of related locations for each corrected location associated with a last known location and trajectory. The corrected location, e.g., the location corresponding to the center of the circular region or the location of the mall, may be provided in response to receiving the last known location and trajectory.

The mobile device 102 may be coupled to the server 104 via network 106. A community of users 108 may similarly be coupled to the server 104 by network 106. The community of users 108 includes one or more other mobile devices 103A, . . . , 103N. It should be noted that any one or more of the other mobile devices 103A, . . . , 103N in the community of users 108 may or may not be coupled to the network 106 and/or the server 104 at a given point in time. Each of the other mobile devices 103A, . . . , 103N in the community of users 108 may include a location application, a location signal receiver, a location store, a trajectory store and a location correction application as described herein with respect to mobile device 102. Although shown separately for ease of illustration, mobile device 102 may be included in the community of users 108.

The server 104 may include a location service application 140 and a master location correction list 142. The server 104 may correspond to one or more servers in a plurality of server, i.e., may be in the cloud. The server 104 may include at least one processor CPU 154 configured to execute one or more applications. The master location correction list 142 may include a database of corrected locations, associated trajectories and associated last known locations. The location service application 140 may be configured to receive a trajectory 132 and a last known location 124 from a mobile device, e.g., mobile device 102. The location service application 140 may then query the master location correction list 142 for a corrected location corresponding to the received trajectory and received last known location. Corrected location(s) returned in response to the query may then be provided to mobile device 102, and may be utilized by location correction application 126 to update the current location 122 stored in the location store 118 with a corrected location.

The master location correction list database 142 may include a plurality of corrected locations. The trajectory 132 and last known location 124 may be used as indexes into the database 142 to find one or more corrected locations that correspond to the trajectory 132 and last known location 124. A mobile device, e.g., mobile device 102, in the absence of the location signal(s) 112, is generally unable to determine its actual location without additional information/input. The community of users 108 may provide this additional information to the server 104 in order to populate the master location correction database 142 with corrected locations and their associated last known locations and associated trajectories. The location service application 140 is configured to manage this information and to respond to requests from a mobile device for its corrected current location based on its trajectory and last known location.

The master location correction database 142 may be populated with corrected locations, associated last known locations and associated trajectories provided by users via their mobile devices. For example, when a location is encountered where the location signal(s) 112 are lost, the user may be asked to enter the actual location. The actual location, last known location and trajectory may be uploaded to the server 104 by, e.g., the location correction application 126. The location service application 140 is configured to store the actual location, last known location and trajectory in the master location correction list 142 and to associate the last known location and the trajectory with the stored actual (potential corrected) location.

A number of users may be asked to enter their actual locations to ensure accuracy of user-provided locations. For example, for a “new” last known location and trajectory, a first user and a number of subsequent users may be asked to enter their actual locations to initially populate and verify the corrected location(s) associated with this “new” last known location and trajectory. In another example, random users may be asked to enter their actual locations for a last known location and trajectory. The random selection is configured to ensure the continuing accuracy of the corrected location database. In another example, when a corrected location is provided to mobile device 102 in response to a last known location and trajectory, the location service application 140 may be configured to update a weight associated with that corrected location if the user does not provide a new actual location. Implicit confirmation of the accuracy of the corrected locations in the list of corrected locations may thus be maintained. Deleterious effects of purposeful or inadvertent uploading of erroneous locations may then be minimized.

If a trajectory and last known location correspond to more than one corrected location, the master location correction list 142 may include weights associated with each of the corrected locations. The weights are configured to indicate a likelihood that the associated corrected location is an accurate actual location. Entering actual locations more than once and associating weights with corrected locations are configured to eliminate erroneous actual locations from the master location correction database 142.

For example, if a first user provides a first trajectory and a first last known location to the server 104 with a request for a corrected location and a query of the master location correction list 142 does not yield a corresponding corrected location, the first user may be asked to provide a first actual location. The first actual location may then be stored in the master location correction database 142 as a first potential corrected location and associated with the first last known location and first trajectory. A first weight may be associated with the first potential corrected location. A second user may then provide the first last known location and first trajectory to server 104 with a request for a corrected location. The second user may be asked to provide a second actual location corresponding to the first last known location and the first trajectory or may be provided the first potential corrected location and asked to confirm its accuracy. If the second actual location is the same as the first potential corrected location or the second user vouches for the accuracy of the first potential corrected location, the first weight may be increased. A number of subsequent users that provide the first last known location and first trajectory to the server 104 may be asked to provide their actual locations or may be provided the first potential corrected location and asked to confirm its accuracy. If the subsequent actual locations are the same as the first potential corrected location or the first potential corrected location is confirmed, the first weight may be further increased, verifying that the first potential corrected location is a correct location corresponding to the first last known location and the first trajectory.

If a first portion of the provided actual locations are the same as the first potential corrected location and a second portion correspond to a second potential corrected location, the first potential corrected location and second potential corrected location may be provided to a third (subsequent) user (via the user's mobile device) in response to receiving the first last known location, first trajectory and a request for a corrected location from the subsequent user. The first potential corrected location and second potential corrected location may be provided in an ordered list with the order determined by a relative size of the weights associated with the first potential corrected location and second potential corrected location. For example, the potential corrected location with the highest associated weight may be first on the ordered list. Thus, the third (subsequent) user may be provided an indicator of a likelihood that a corrected location is accurate.

If the second actual location (corresponding to the first last known location and the first trajectory) provided by the second user does not correspond to the first potential corrected location or the second user does not confirm the first potential corrected location, the first weight may be reduced or may remain unchanged. If actual locations (corresponding to the first last known location and the first trajectory) provided by subsequent users do not correspond to the first potential corrected location, the first weight may be decreased. The first potential corrected location may be pushed to a bottom of the weighted list and/or may be removed from the master location correction database 142 if the first weight is reduced to below a first threshold. It is contemplated that, in some embodiments, the user(s) associated with the potentially erroneous first potential corrected location may be penalized. Thus, erroneous user-provided actual locations may be removed from the master location correction database 142, ensuring the accuracy of the corrected locations in the database.

Once the database 142 has been populated, random subsequent users may be asked to provide an actual location. Other subsequent users may benefit from the additional information provided by the community of users configured to allow a mobile device to reliably determine its location when the location signal(s) 112 are lost. Subsequent users may have the option of providing a new or updated actual location in response to receiving a corrected location. For example, a function of a location may change, e.g., a store becomes a restaurant or a new store may open in a shopping mall. The database 142 may then be utilized by mobile device 102 and other mobile devices 103A, . . . , 103N without user input to determine and/or correct the device's current location after the location signal(s) have been lost.

It is contemplated that in some embodiments, when the location signal is lost and the user is asked to enter his/her actual location, a list of possible actual locations may be provided to the user. This list of possible actual locations may be based on (i.e., may be provided by) the location app. For example, if the last known location was acquired relatively recently (e.g., within five minutes), and the location app is a commercial location app (e.g., Google Maps, Yahoo Maps, or Mapquest), the location app may be queried to provide locations near the last known location. Locations may include stores, businesses and the like. In this manner, the user may be helped to enter his/her current location by selecting from a list rather than having to type in his/her location.

A user may be given an incentive for providing an actual location to the server 104 for inclusion in the master location correction list 142 that is subsequently verified as an accurate corrected location. For example, if the first weight associated with the first potential corrected location is increased to a second threshold, the first user may be provided a reward. Rewards may include, but are not limited to, coupons, merchandise, cash and/or other incentives. Such a reward system is configured to provide the community of users an incentive to populate the master location correction list 142 so that it includes both heavily used corrected locations as well as less heavily used corrected locations.

Mobile device 102 may include a local device location correction list 150. The device location correction list 150 may include at least a portion of master location correction list 142. The location correction application 126 may be configured to store frequently and/or recently used corrected locations, their associated trajectories and associated last known locations. The location correction application 126 may be configured to store corrected locations when a user enters a physical area that includes location(s) that are stored in the master location correction database 142 (as last known location(s)). For example, when a user travels to a new area, location correction data may be downloaded when the user arrives in or approaches near the new area.

The server 104 may include a plurality of device location correction lists 152. Each of the plurality of device location correction lists 152 may be uploaded from a respective mobile device and may correspond to a respective device location correction list, e.g., device location correction list 150, stored on the respective mobile device. Each device location correction list may be associated with a respective user. Each device location correction list may be pushed to another of the respective user's mobile devices, e.g., at the request of the respective user. Thus, a user's location correction “history” may be copied to any one of the user's mobile devices.

Thus, a master location correction database 142 may be established in a server 104 and may be managed by a location service application 140. The master location correction database 142 may be populated by a community of users 108. Weights may be utilized to ensure that accurate and/or most likely corrected located locations are provided to a requesting mobile device. The master location correction database 142 may then be utilized by a mobile device 102 to correct a current location, based on last known location and trajectory, when the location signal(s)are unavailable (become lost). Location-based services and/or applications may then operate properly in the absence of the location signal(s).

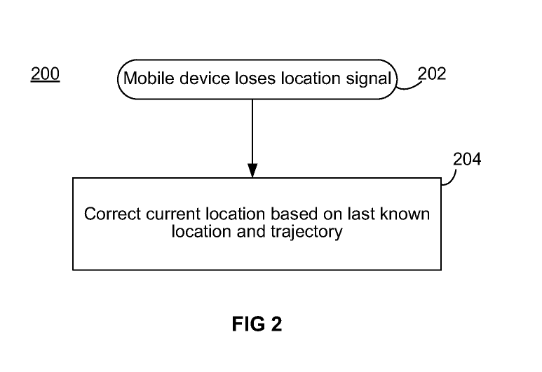

FIG. 2 illustrates a flowchart 200 of exemplary operations consistent with an embodiment of the present disclosure. The operations may be performed, for example, by the mobile device 102, other mobile devices in the community of users 108 and/or the server 104. In particular, flowchart 200 depicts exemplary operations configured to provide a corrected current location when a location signal is lost. The operations of flowchart 200 may be initiated 202 in response to location signal(s) 112 being lost or unavailable. Operation 204 includes correcting a location of a mobile device based on a last known location and a trajectory. The corrected location may correspond to an actual location that has been provided by at least one user of a community of users and stored in a list of corrected locations, as described herein. The actual location may be related to the last known location and the trajectory. For example, the actual location may be associated with the last known location and associated with the trajectory in the list of corrected locations.

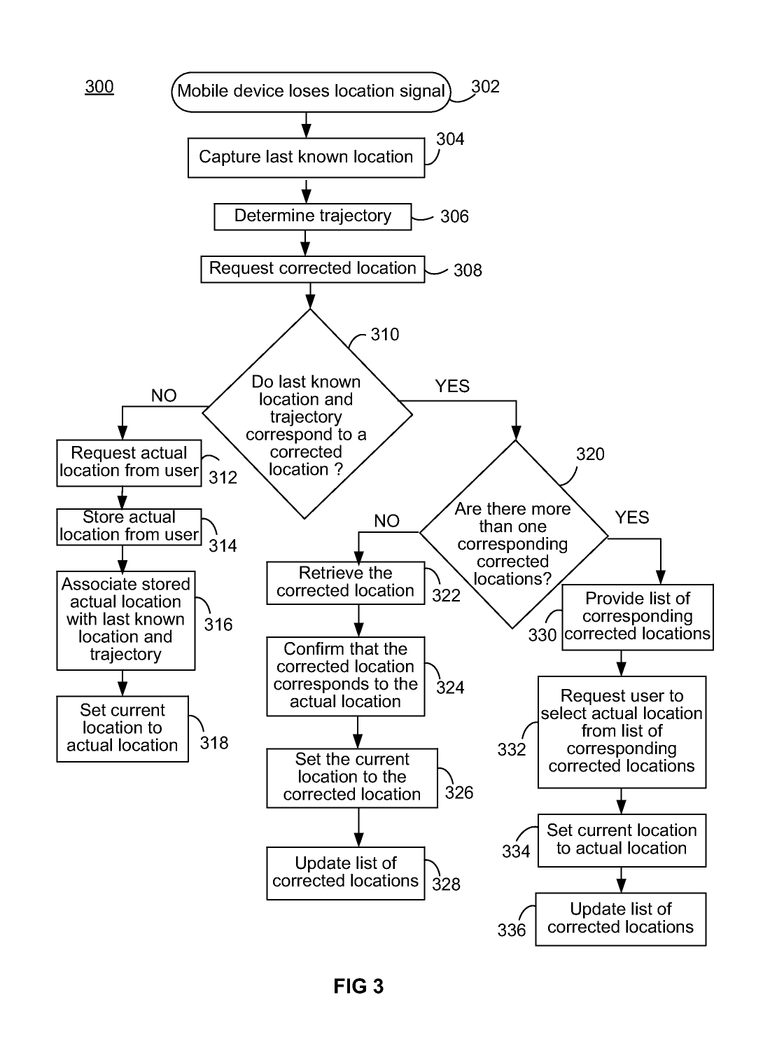

FIG. 3 illustrates a flowchart 300 of exemplary operations consistent with one embodiment of the present disclosure. The operations may be performed, for example, by the mobile device 102, other mobile devices 103A, . . . , 103N in the community of users 108 and/or the server 104. In particular, flowchart 300 depicts exemplary operations configured to provide a corrected current location when a location signal is lost.

The operations of flowchart 300 may be initiated 302 in response to location signal(s) 112 being lost or unavailable. Operation 304 includes capturing a last known location. The last known location corresponds to the last current location determined just prior to the location signal(s) becoming lost. For example, the last known location may correspond to the current location or a prior location. Whether the last known location corresponds to the current location or a prior location depends on whether the current location has been updated after the location signal was lost (e.g., updated based on an alternate signal). A trajectory may be determined at operation 306. For example, the last known location and one or more prior location(s) may be utilized to determine a trajectory.

Operation 308 may include requesting a corrected current location. The corrected current location may be requested by a mobile device (e.g., by a location correction application) and/or may be requested by a user of the mobile device (e.g., by selecting a “correct location” icon displayed on the mobile device). The request may be responded to locally, e.g., using location correction data stored on the requesting mobile device or the request may be responded to remotely by, e.g., a location service, executing on a remote server. Whether the last known location and trajectory correspond to a corrected location may be determined at operation 310. For example, the corrected location may be stored in a master location correction list on a server that includes a location service. The location service is configured to manage the location correction list and to respond to requests from mobile devices for corrected current locations. In another example, the corrected location may be stored in a device location correction list on the mobile device.

If the last known location and trajectory do not correspond to a corrected location, an actual location may be requested from a user at operation 312. The actual location received from the user (i.e., potential corrected location) may be stored at operation 314. For example, the actual location may be stored in the device location correction list on the mobile device and/or in the master location correction list in the server. The stored actual location (potential corrected location) may be associated with the last known location and the trajectory at operation 316. The current location may be set to the stored actual location at operation 318.

If the last known location and trajectory correspond to a corrected location, whether there are more than one corresponding corrected locations may be determined at operation 320. If there are not more than one corresponding corrected locations, the corrected location may be retrieved at operation 322. Operation 324 may include confirming that the corrected location corresponds to the actual location. For example, the user may be asked to confirm that the corrected location corresponds to the actual location and to provide the actual location if the corrected location does not correspond to the actual location. A weight associated with the stored corrected location may be updated if the corrected location does not correspond to the actual location, as described herein. Operation 326 may include setting the current location to the corrected location. Operation 328 may include updating a list of corrected locations (location correction database(s)). For example, a weight associated with the corrected location may be adjusted to reflect confirmation of the corrected location (as corresponding to the actual location given the last known location and trajectory).

If there are more than one corresponding corrected locations (for the last known location and trajectory), a list of corrected locations may be provided at operation 330. The corrected locations in the list of corrected locations may be associated with the last known location captured and trajectory determined at operations 304 and 306, respectively. The user may be asked to select an actual location from the provided list of corresponding corrected locations at operation 332. Operation 334 may include setting the current location to the actual location (i.e., selected corrected location). The list of corrected locations may be updated at operation 336. For example, the weight associated with the corrected location corresponding to the user-selected actual location may be increased to indicate an increased likelihood that this corrected location is the actual location for the last known location and trajectory.

Thus, a database (list) of corrected locations with associated last known locations and trajectories may be populated by a community of users. Thereafter, when a mobile device loses a location signal, a corrected current location may be provided to the mobile device (based on its last known location and trajectory) from the database of corrected locations. Location-based applications may then function as designed, using the corrected current location of the mobile device.

While FIG. 3 illustrates various operations according one embodiment, it is to be understood that not all of the operations depicted in FIG. 3 are necessary for other embodiments. Indeed, it is fully contemplated herein that in other embodiments of the present disclosure, the operations depicted in FIG. 3 and/or other operations described herein may be combined in a manner not specifically shown in any of the drawings, but still fully consistent with the present disclosure. Thus, claims directed to features and/or operations that are not exactly shown in one drawing are deemed within the scope and content of the present disclosure.

Any of the operations described herein may be implemented in a system that includes one or more storage mediums having stored thereon, individually or in combination, instructions that when executed by one or more processors perform the methods. Here, the processor may include, for example, a server CPU, a mobile device CPU, and/or other programmable circuitry. Also, it is intended that operations described herein may be distributed across a plurality of physical devices, such as processing structures at more than one different physical locations. The storage medium may include any type of tangible medium, for example, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of media suitable for storing electronic instructions. Other embodiments may be implemented as software modules executed by a programmable control device. The storage medium may be non-transitory.

Mobile device 102 and the community of users may be configured to communicate with network 106 and/or server 104 using a variety of communication protocols. The communications protocols may include but are not limited to wireless communications protocols, such as NFC, RFID, Wi-Fi, Bluetooth, 3G, 4G and/or other communication protocols. The Wi-Fi protocol may comply or be compatible with the 802.11 standards published by the Institute of Electrical and Electronics Engineers (IEEE), titled “IEEE 802.11-2007 Standard, IEEE Standard for Information Technology-Telecommunications and Information Exchange Between Systems-Local and Metropolitan Area Networks-Specific Requirements—Part 11: Wireless LAN Medium Access Control (MAC) and Physical Layer (PHY) Specifications” published, Mar. 8, 2007, and/or later versions of this standard.

The NFC and/or RFID communication signal and/or protocol may comply or be compatible with one or more NFC and/or RFID standards published by the International Standards Organization (ISO) and/or the International Electrotechnical Commission (IEC), including ISO/IEC 14443, titled: Identification cards—Contactless integrated circuit cards—Proximity cards, published in 2008; ISO/IEC 15693: Identification cards—Contactless integrated circuit cards—Vicinity cards, published in 2006, titled: ISO/IEC 18000, titled: Information technology—Radio frequency identification for item management, published in 2008; and/or ISO/IEC 18092, titled: Information technology—Telecommunications and information exchange between systems—Near Field Communication—Interface and Protocol, published in 2004; and/or later versions of these standards.

The Bluetooth protocol may comply or be compatible with the 802.15.1 standard published by the IEEE, titled “IEEE 802.15.1-2005 standard, IEEE Standard for Information technology—Telecommunications and information exchange between systems—Local and metropolitan area networks—Specific requirements Part 15.1: Wireless Medium Access Control (MAC) and Physical Layer (PHY) Specifications for Wireless Personal Area Networks (W Pans)”, published in 2005, and/or later versions of this standard.

The 3G protocol may comply or be compatible with the International Mobile Telecommunications (IMT) standard published by the International Telecommunication Union (ITU), titled “IMT-2000”, published in 2000, and/or later versions of this standard. The 4G protocol may comply or be compatible with IMT standard published by the ITU, titled “IMT-Advanced”, published in 2008, and/or later versions of this standard.

For example, network 106 may comprise a packet switched network. Mobile device 102 and/or the community of users 108 may be capable of communicating with the server 104 using a selected packet switched network communications protocol. One exemplary communications protocol may include an Ethernet communications protocol which may be capable permitting communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard”, published in March, 2002 and/or later versions of this standard. Alternatively or additionally, mobile device 102 and/or community of users 108 may be capable of communicating with server 104, using an X.25 communications protocol. The X.25 communications protocol may comply or be compatible with a standard promulgated by the International Telecommunication Union-Telecommunication Standardization Sector (ITU-T). Alternatively or additionally, mobile device 102 and/or community of users 108 may be capable of communicating with server 104, using a frame relay communications protocol. The frame relay communications protocol may comply or be compatible with a standard promulgated by Consultative Committee for International Telegraph and Telephone (CCITT) and/or the American National Standards Institute (ANSI). Alternatively or additionally, mobile device 102 and/or community of users 108 may be capable of communicating with server 104, using an Asynchronous Transfer Mode (ATM) communications protocol. The ATM communications protocol may comply or be compatible with an ATM standard published by the ATM Forum titled “ATM-MPLS Network Interworking 1.0” published August 2001, and/or later versions of this standard. Of course, different and/or after-developed connection-oriented network communication protocols are equally contemplated herein.

“Circuitry”, as used in any embodiment herein, may comprise, for example, singly or in any combination, hardwired circuitry, programmable circuitry, state machine circuitry, and/or firmware that stores instructions executed by programmable circuitry. An application (“app”), as used in any embodiment herein, may be embodied as circuitry. The circuitry may be embodied as an integrated circuit, such as an integrated circuit chip.

Thus, the present disclosure provides a method and system for location correction for a mobile device when a location signal is unavailable (lost). A database of corrected locations may be populated by a community of users. A corrected current location may then be selected from the database based on a last known location and a trajectory of the mobile device. Location-dependent applications may then utilize the corrected current location.

According to one aspect there is provided a method. The method may include correcting a location of a mobile device when a location signal is lost based on a last known location and a trajectory, wherein a corrected location corresponds to an actual location provided by at least one user of a community of users and stored in a list of corrected locations, and the actual location is related to the last known location and the trajectory.

According to another aspect there is provided a system. The system may include a mobile device configured to correct a location of the mobile device when a location signal is lost based on a last known location and a trajectory, wherein a corrected location corresponds to an actual location provided by at least one user of a community of users and stored in a list of corrected locations, and the actual location is related to the last known location and the trajectory.

According to another aspect there is provided a system. The system may include one or more storage mediums having stored thereon, individually or in combination, instructions that when executed by one or more processors result in the following operations comprising: correcting a location of a mobile device when a location signal is lost based on a last known location and a trajectory, wherein a corrected location corresponds to an actual location provided by at least one user of a community of users and stored in a list of corrected locations, and the actual location is related to the last known location and the trajectory.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

1-21. (canceled)

22. A method comprising:
correcting a location of a mobile device when a location signal is lost based on a last known location and a trajectory, wherein a corrected location corresponds to an actual location provided by at least one user of a community of users and stored in a list of corrected locations, and the actual location is related to the last known location and the trajectory.

23. The method of claim 22, further comprising:
determining the trajectory of the mobile device based, at least in part, on a prior location of the mobile device wherein the prior location was determined based on the location signal.

24. The method of claim 22, further comprising:
capturing the last known location of the mobile device in response to losing the location signal wherein the last known location was determined based on the location signal.

25. The method of claim 22, wherein the correcting is performed in response to losing the location signal.

26. The method of claim 22, wherein the correcting is performed in response to an input from a user of the mobile device.

27. The method of claim 22, further comprising:
selecting the corrected location from the list of corrected locations based on the last known location and the trajectory.

28. The method of claim 22, further comprising:
updating a weight corresponding to the selected corrected location in the list of corrected locations in response to receiving the actual location.

29. A system, comprising:
a mobile device configured to correct a location of the mobile device when a location signal is lost based on a last known location and a trajectory, wherein a corrected location corresponds to an actual location provided by at least one user of a community of users and stored in a list of corrected locations, and the actual location is related to the last known location and the trajectory.

30. The system of claim 29, wherein the mobile device is further configured to determine the trajectory of the mobile device based, at least in part, on a prior location of the mobile device wherein the prior location was determined based on the location signal.

31. The system of claim 29, wherein the mobile device is further configured to capture the last known location of the mobile device in response to losing the location signal wherein the last known location was determined based on the location signal.

32. The system of claim 29 wherein the mobile device is configured to receive an input from a user of the mobile device and to perform the correcting in response to the input from the user.

33. The system of claim 29, further comprising a server configured to store the list of corrected locations.

34. The system of claim 33, wherein the server is further configured to select the corrected location from the list of corrected locations based on the last known location and the trajectory.

35. A system comprising one or more storage mediums having stored thereon, individually or in combination, instructions that when executed by one or more processors result in the following operations comprising:
correcting a location of a mobile device when a location signal is lost based on a last known location and a trajectory, wherein a corrected location corresponds to an actual location provided by at least one user of a community of users and stored in a list of corrected locations, and the actual location is related to the last known location and the trajectory.

36. The system of claim 35, wherein the instructions that when executed by one or more processors results in the following additional operations:
determining the trajectory of the mobile device based, at least in part, on a prior location of the mobile device wherein the prior location was determined based on the location signal.

37. The system of claim 35, wherein the instructions that when executed by one or more processors results in the following additional operations:
capturing the last known location of the mobile device in response to losing the location signal wherein the last known location was determined based on the location signal.

38. The system of claim 35, wherein the correcting is performed in response to losing the location signal.

39. The system of claim 35, wherein the correcting is performed in response to an input from a user of the mobile device.

40. The system of claim 35, wherein the instructions that when executed by one or more processors results in the following additional operations:
selecting the corrected location from the list of corrected locations based on the last known location and the trajectory.

41. The system of claim 35, wherein the instructions that when executed by one or more processors results in the following additional operations:
updating a weight corresponding to the selected corrected location in the list of corrected locations in response to receiving the actual location.
